(19) United States
(12) Patent Application Publication
(10) Pub. No.: US 2017/0004178 A1
(43) Pub. Date: Jan. 5, 2017

(54) REFERENCE VALIDITY CHECKER

(71) Applicant: Avaya Inc., Santa Clara, CA (US)

(72) Inventors: Keith Ponting, West Malvern (GB); Wendy J. Holmes, Malvern (GB); David Skiba, Golden, CO (US); Ajita John, Holmdel, NJ (US)

(21) Appl. No.: 14/788,452

(22) Filed: Jun. 30, 2015

(51) Int. Cl. G06F 17/30; G10L 15/26

(52) U.S. Cl. CPC G06F 17/30528; G10L 15/26; G06F 17/30867; G06F 17/3053

(57) ABSTRACT

Conferences comprise a number of listening, viewing, and/or speaking participants. A conference participant may ask a question or make a statement that can be answered or verified against an authoritative source. A reference validity checker is provided to receive the conference content, recorded or in real-time, determine that a question or statement was made that can be answered or verified, query a knowledgebase, and present indicia of the response. The indicia may be an indicator (e.g., true/false, verified, etc.) and/or a link to a source, such as a particular entry in a knowledgebase. The knowledgebase may be selected from internal sources or external sources depending on factors, such as the type of question/statement or topic associated therewith. The indicia may annotate a transcript or recording of the conference so that a subsequent review may have the ability to locate the source of the answer/response as desired.

### FIELD OF THE DISCLOSURE

The present disclosure is generally directed toward speech recognition and reference identification.

### BACKGROUND

Conference calls are often recorded and automatically transcribed using natural language processing methods, including speech processing, summarization, segmentation, question-answering, sentiment analysis, and tagging. Systems and processes have focused on the detection, conversion, translation, and classification of spoken information. While such systems and processes have proven valuable, the solutions they provide are incomplete.

### SUMMARY

It is with respect to the above issues and other problems that the embodiments presented herein were contemplated. In one embodiment of the present disclosure, systems and methods for reference validity checking are provided that utilize natural language processing, speech recognition, meeting annotation, and a search function to internally and/or externally validate references associated with or mentioned during a conference call.

Conference calls are a routine part of many business, academic, and other organizational activities. Often a conference call participant will mention/cite information in the form of a reference, such as to a paper, website, book, request for change (RFC), etc.

In one embodiment, a reference validity checker is provided that utilizes natural language processing, speech recognition, meeting annotation, and/or a search function to validate the aforementioned reference. As a benefit of certain embodiments disclosed herein, the information may be associated with a source and/or validated to assist conference users and/or administrators both during the call and afterwards. For example, referenced information may be indicated as valid, invalid, unconfirmed, or other annotation summarizing a result of an attempt to validate the information. A link or other identifier may be provided to a source or sources of the information to allow individuals to validate the referenced information or locate additional information. Additionally, documents related to the referenced information of a conference may be stored with or linked to a transcription of the conference.

Natural language processing may be used in real-time conferences, as well as recorded conferences, to provide speech-to-text, tagging, annotation, and other services. The resulting data (e.g., transcription file, annotation file, etc.) may further include or be associated with one or more features to perform and/or enable validity checking. In one embodiment, a system is configured to search internal and/or external data sources to validate the authenticity or other details of a reference. A response from the system, such as in a meeting or conference, allows participants to interact with the system during its response process.

While many embodiments disclosed herein refer to the spoken portion of a conference, it should be appreciated that text “chat” based conferences, email processing, documents, or other communications, which may or may not include speech, are also contemplated by the embodiments disclosed herein.

In one embodiment, a conference is underway and speech recognition technology is employed to transcribe the contents of the meeting in real time. In another embodiment, a conference is recorded and the speech recognition process analyzes the recording. The text, such as the transcript of the live or recorded conference and optionally other materials are analyzed by a natural language processing (NLP) engine. The NLP engine then searches for types of questions or declarative statements that may be trying to assert a fact and, using syntactic and semantic processing, the subjects, objects, and verbs are identified to allow the NPL engine to discover the potential topics of questions. Example statements may include: “The conference is in March next year;” “Flights to NYC are still over $300 for the July conference;” “It will take you four hours to drive from the Frankfurt office to Berlin;” and, “The new release has not been released yet; it should be available in March.”

It is possible that some information may need to be inferred. In one embodiment, dates, times, and locations, as well as other references, such as to corporate acronyms, products, etc. may be inferred from a speech portion. For example, “the conference in July” may be determined to be a colloquial term to a specific conference (e.g., “Enterprise Connect”).

After identifying a topic, a reference check is performed. This may be embodied as accessing a public and/or private knowledgebase and/or any other configured trusted sources of information. In another embodiment, the knowledgebase comprises static content stored therein (e.g., historical events, data, etc.). In another embodiment, the knowledgebase comprises dynamic information, including but not limited to, the current location of an item or person, the score of a game, current financial information, etc.

A set of results may then be ranked and displayed in a reference checker window to one or more conference participants or a reviewer. The display identifies the segment investigated along with the discovered facts Links and/or summary information may be included for easy human navigation and checking; for example, an offline-mode may present similar display features. Participants without visual displays or with limited visual displays might not be able or want to view reference checking information or have the information presented in a different format (e.g., tactile, spoken, etc.)

In another embodiment, one or more participants and/or reviewers may be allowed to validate or reject the automatic fact checker, and thus strengthen the process that found the information. In such an embodiment, a system may be self-learning and better able to access more accurate information associated with a topic. For example, “the conference” may be referenced and human-validated to select, confirm, and/or validate system responses and provide a means to indicate preferred sources for future searches, which may include a later portion of the same conference. Accordingly, future references to “the conference,” “conference,” or similar terminology (e.g., meeting, symposium, presentation, etc.) may emphasize results found on calendars over results obtained from an Internet search engine.

In another embodiment, security/permission measures are implemented to only allow specific participants access and the ability to use one or more features disclosed herein.

In another embodiment, an inferred question may be derived from a conversation. The topic of the discussion may be detected through speech search technologies. External sources could be used, such as Internet search engines (e.g., Google, Bing, etc.), current trends (e.g., Twitter, Facebook, etc.), and other sources. In another method, the ontology of specific words or phrases, syntax, and semantics is utilized to gain insight as to what common questions might be. The known attributes of the business, products, industry, etc could also help guide these auto-generated questions. For example, if the meeting contains a discussion and the statement, “We should look to integrate with the new truck offers in the US,” is spoken, the term “truck” may be identified to derive further questions for research like, “Who sells trucks in the US?” and “What was the production of truck manufacturers?” and “How many truck models are available this year?” The inferred questions may be generated and verified as if they were explicitly asked.

As a benefit of certain embodiments disclosed herein, the resulting recordings are enhanced with contextual knowledge and derivative questions, thereby increasing its value as a reference and a knowledge source. This allows a person who is listening to the recording to better understand and have confidence in the discussion and in the answers. This is due to the additional questions and answers that are provided with annotated and verified references.

In one embodiment, a system is disclosed, comprising: a network connection configured to access a conference stream comprising conference content provided by a number of conference participants; a processor configured to analyze the conference stream to identify a respondable statement provided by at least one of the number of conference participants; the processor being further configured to, upon identifying the respondable statement, access a knowledgebase and obtain a response to the respondable statement from the knowledgebase; and the processor being further configured to provide indicia of the response.

In another embodiment, a method is disclosed, comprising: accessing a conference stream comprising conference content provided by a number of conference participants; analyzing the conference stream to identify a respondable statement provided by at least one of the number of conference participants; upon identifying the respondable statement, accessing a knowledgebase and receiving a response to the respondable statement from the knowledgebase; and providing indicia of the response.

In another embodiment, a non-transitory computer-readable medium is disclosed with instructions thereon that when read by the computer cause the computer to perform: accessing a conference stream comprising conference content provided by a number of conference participants; analyzing the conference stream to identify a respondable statement provided by at least one of the number of conference participants; upon identifying the respondable statement, accessing a knowledgebase and responding to the respondable statement with the knowledgebase; and providing indicia of the response.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a diagram in accordance with embodiments of the present disclosure;

FIG. 3 depicts a display in accordance with embodiments of the present disclosure;

FIG. 4 depicts a transcript in accordance with embodiments of the present disclosure;

FIG. 5 depicts a communication system in accordance with embodiments of the present disclosure; and

FIG. 6 depicts a process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

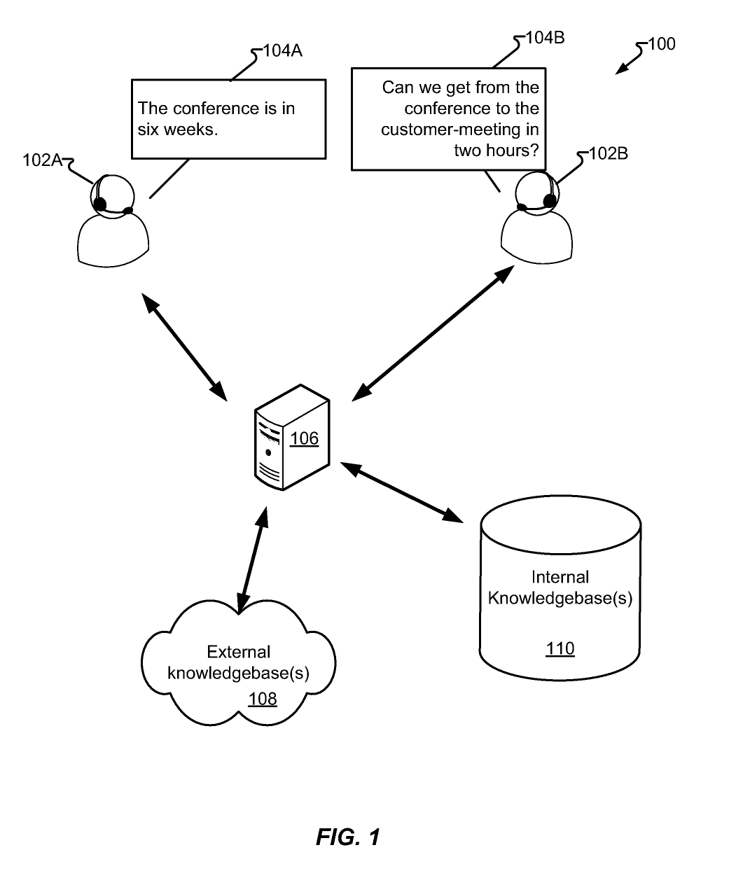

FIG. 1 depicts system 100 in accordance with embodiments of the present disclosure. In one embodiment, speaker 102A and speaker 102B are engaged in a real-time conference utilizing server 106. Speaker 102A provides a portion of the audio for the conference, including spoken dialog 104A. Speaker 102B provides another portion of the conference, including spoken portion 104B. Server 106 provides connectivity and other resources to facilitate the conference.

In one embodiment, speakers 102 provide audio portions, such as spoken dialog 104, which are then processed by server 106. Server 106 may provide conventional conferencing functionality, such as conference participant management, floor control, transcription, and/or other services. In addition to any conventional functionality provided by server 106, in one embodiment, server 106 provides a natural language analysis on the speech provided by the conference participants (e.g., speaker 102A, 102B, etc.). The analysis provided by server 106 may further include a reference checker.

The reference checker functionality of server 106 may access one or more data repositories, including internal knowledgebase 110 and external knowledgebase 108. In one embodiment internal knowledgebase 110 provides access to locally known information, such as names of the employees, calendared events, terminology, products, services, etc. Additionally, internal knowledgebase 110 may provide access to historical conferences, conference transcripts, notes, prior searches, and/or other historical content. External knowledgebase 108 may provide access to data external to a particular company, organization, group, or other collection and may further be publicly available (e.g., via the Internet). External knowledgebase 108, when embodied as the Internet, may access publicly available websites and other data repositories to access information publicly available and/or privately available when associated with the user being duly authorized to access the privately available information.

In one embodiment, speaker 102A provide spoken dialog 104A. The dialogue spoken in 104A may be analyzed in real-time or may be a recorded version thereof. Server 106 may be configured to automatically extract words and phrases for analysis and reference checking. In another embodiment, server 106 may be configured to respond to an explicit request for reference checking. For example, speaker 102B may say, “check that.” As a result, server 106 may then parse the last portion of what was spoken by either speaker 102B or another speaker, such as speaker 102A. The last portion is then analyzed for checkable content and, as provided in more detail with respect to the embodiments that follow, is presented to speaker 102B and/or speaker 102A along with the results of the reference check. In performance-constrained systems, an explicit request may cause other requests to be paused or de-prioritized so as to provide a more prompt response to the explicit query.

In order to provide reference checking functionality, server 106 may utilize conventional and/or proprietary speech-to-text recognition in order to translate the spoken portion of the conference into text. The text is then parsed into explicit questions, sentences, sentence fragments, nouns, verbs, and/or other portions of speech in which a question is asked or a statement is made (e.g., a respondable statement). It should be appreciated, that systems may be provided that omit the speech-to-text portion and operate directly on the spoken portion of the conference. It should also be appreciated that in another embodiment the conference may comprise a single speaker, such as one performing a dictation. Additionally, omitting speech-based processing and applying certain embodiments disclosed herein to text-based communication (e.g., email, text messages, etc.) is also contemplated.

In another embodiment, server 106 may determine which statements require verification based upon certain cues provided by speaker 102A. In one embodiment, the respondable statement is an explicit question, which may or may not be followed by an answer from the speaker 102A or another conference participant (e.g., speaker 102B). For example, speaker 102A may ask the question, “what time is the meeting tomorrow?” In one embodiment, server 106 accesses internal knowledgebase 110 to determine which events are presently calendared for certain personnel, such as speaker 102A and/or speaker 102B. If an event is identified as a “meeting,” server 106 may then present the time for such a meeting to speakers 102A and 102B. The presentation of the information may be textual, such as a pop-up window, message alert, or other real-time notification. Additionally and/or alternatively, server 106 may provide notification after the fact, such as in a transcript, message, email, or other notification to confirm the time for the meeting.

In another embodiment, server 106 is unable to reach a definitive conclusion as to which meeting is being referenced. For example, server 106 may be unable to determine which participants of the meeting are being referenced, such as when server 106 determines whether parties have been identified and defaults to consideration of speakers 102A and 102B being referenced as attending the meeting. However, if neither speaker 102A nor speaker 102B have any meeting scheduled for tomorrow, server 106 may provide a notification that verification could not be provided. Alternatively, the participants of the meeting may be identified with the least certain probability above a minimum threshold, such as when one or both of speakers 102A and 102B have a meeting scheduled for the following day. However, if there are multiple meetings scheduled for the participants, as provided by internal knowledgebase 110, server 106 may provide a listing of the potential meetings as a validation.

In another embodiment, speaker 102B may respond to the question, for example, “10:00 AM in the main conference room.” In response to the answer being provided in the conference, server 106 may omit verification, provide a confirmation that the meeting is indeed at the identified time and place, or provide validation confirming the answer provided by speaker 102B.

In another embodiment, server 106 may be configured to validate a reference with one or both of internal knowledgebases 110 and external knowledgebases 108 with a high degree of granularity, such as every verb and noun spoken by any participant in a conference. In another embodiment, the granularity of the search may be determined by the participant, an attribute associated with the participant, or other speaker-dependent criteria. In another embodiment, server 106 may be configured to validate certain key terms, explicit questions, explicit requests for validation, or otherwise limit the validations performed by server 106 to less than every validatable noun and verb. Additionally, server 106 provision of conference services for speakers 102A and 102B may be executed on a device associated with one of the participants, such as a desktop or laptop computer operated by one of speaker 102A or speaker 102B. Server 106 may therefore be of limited capacity and may provide data validation less frequently, such as on only certain keywords, requests, or constrained search criteria.

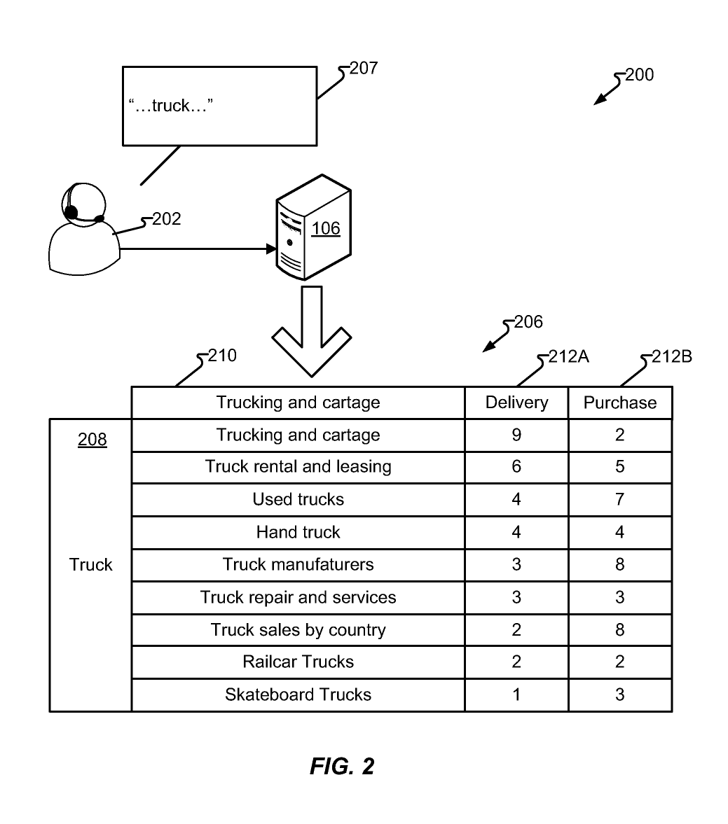

FIG. 2 depicts diagram 200 in accordance with embodiments of the present disclosure. In one embodiment, speaker 202 provides dialogue 207 containing speech provided by speaker 202. Server 106 may translate dialogue 207 into text, such as to facilitate less resource intensive processing in downstream processes. In one embodiment, server 106 determines speaker 202 spoke a keyword (“truck”) and provided it with tag 208.

Server 106, such as by accessing internal knowledgebase 110 and/or external knowledgebase 108, may then determine categories associated with tag 208. As a result, data structure 206 may be constructed comprising an association between tag 208, search results 210, in one or more relevance scores 212A and/or 212B associated with ones of search results 210. Server 106 may further refine search results 210 based upon context provided by speaker 202, an attribute associated with speaker 202 (e.g., job title, role, employer, past conferences, and/or dictations, etc.) and/or additional context that may be extracted by server 106 from dialogue 207.

In one embodiment, server 106 has determined tag 208 is associated with two categories and provided relevance scores (e.g., relevance score 212A and relevance score 212B) associated with each of the two categories. Server 106 may present a prioritized list based upon the selected one or both of first relevance score 212A or second relevance score 212B. For example, server 106 may wait for additional content to be provided in dialogue 207 in order to more fully understand the context of the dialogue and in which category associated with first relevance score 212A or second relevance score 212B is more appropriate to present to speaker 202 and/or another participant or reviewer of dialogue 207. In another embodiment, server 106 may determine a conference-dependent context from, for example, a subject, title, agenda item, or other attribute of the conference. For example, a conference entitled, “Motor Failure Analysis” may weight terms such as “connection” more heavily to electrical connections, as server 106 may discover a connection between motors and electrical connections, as compared to other usages of “connections” (e.g., connections between people and organizations, etc.).

In another embodiment, context may be provided by a party other than speaker 202 providing dialogue 207. For example, another speaker may be engaged in the conference or another party may be identified in dialogue 207. In another example, speaker 202 providing dialogue 207 is related to the acquisition of a large piece of equipment requiring the services of a trucking company. As a result, server 106 may determine first relevance score 212A associated with delivery is more relevant and provide search results 210 according to a relevance score determined by first relevance score 212A

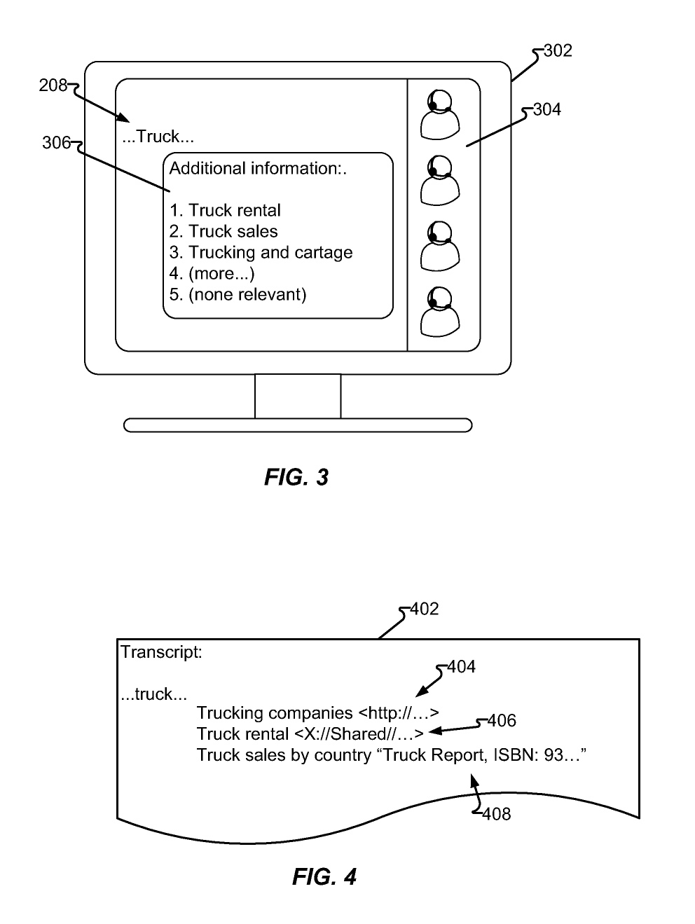

FIG. 3 depicts display 302 in accordance with embodiments of the present disclosure. In one embodiment, display 302 is utilized by a participant of a conference. Display 302 may provide conference information 304 associated with the conference, such as a listing of participants, access to documents, and/or other conference information. Display 302 may be associated with the real-time conference or playback of a prior conference comprising one or more participants.

Display 302 may present validation results 306. Validation results 306 may be prioritized, such as according to data structure 206 and a selected one of first relevance score 212A and second relevance score 212B. Additionally, validation results 206 may allow input allowing a viewer of display 302 to select additional information, dismiss all information, or otherwise provide feedback to server 106 that the results provided in validation results 306 are not relevant or otherwise not useful.

As a benefit of the feedback provided by users input on validation window 306, server 106 may provide a weighting of future search results to further refine relevance scores, such as relevance scores 212A and 212B. Although a single tag 208 is provided herein, it should be appreciated that two or more tags may be utilized in the determination of content provided by validation results 306 and the waiting of any modifications provided from feedback associated with an input from validation results 306.

FIG. 4 depicts transcript 402 in accordance with embodiments of the present disclosure. In one embodiment, transcript 402 is a text-based transcription of the prior conference or dictation. In addition to the speech transcribed, such as including tag 208, validation results 404, 406, 408 may be provided therein. In one embodiment, validation results 404, 406, 408 are provided in line with the transcribed speech. In another embodiment, validation results 404, 406, 408 are provided as a separate portion of the transcription (e.g., table, appendix, etc.).

A viewer of transcript 402 may be doing so via a display, such as display 302, which may provide an ability to embed links to identified sources of data utilized in the validation. For example, a list of trucking companies may be accessible to the user by clicking on link 404 or accessing a website or other document on the Internet or other external knowledgebase 108. In another embodiment, link 406 identifies an internal source of validation accessed from internal knowledgebase 110. Additionally, sources of information may be identified as having relevance but may be inaccessible to server 106, such as when a particular source is available only in paper form. However, if such a document is explicitly requested or otherwise identified as relevant, transcript 402 may be populated with validation result 408 from server 106 providing a viewer of transcript 402 with an indicator of how to access the document.

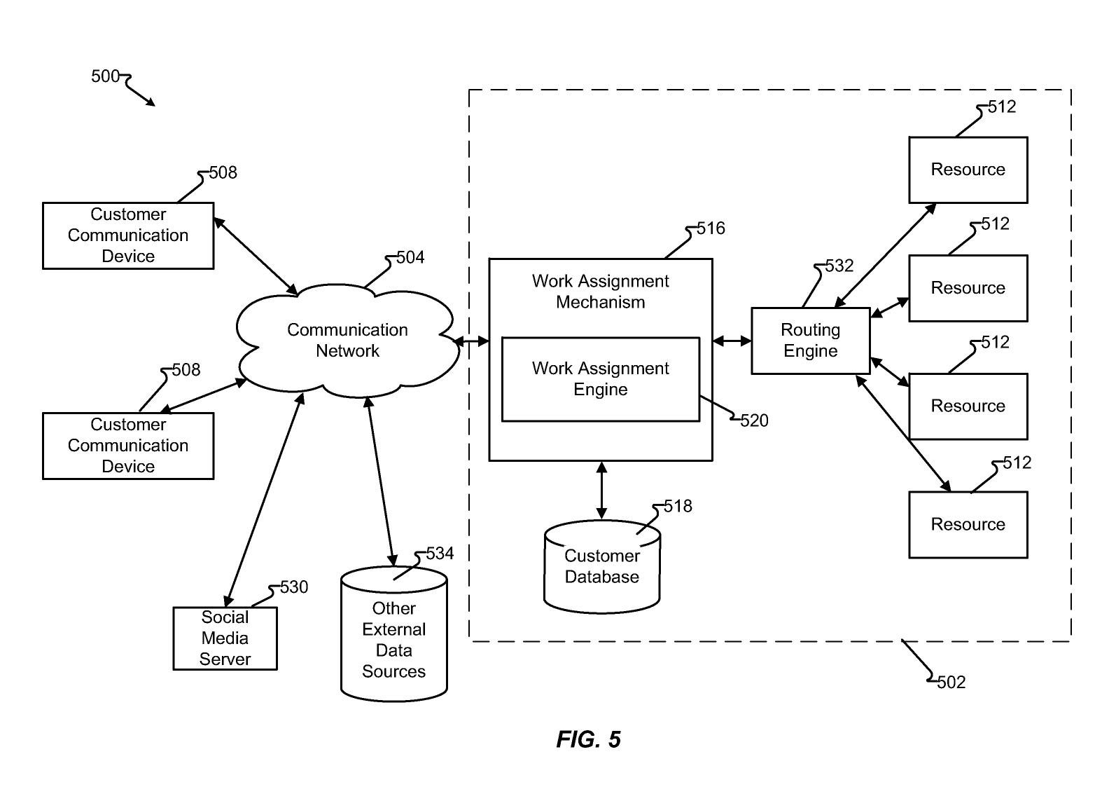

With reference now to FIG. 5, communication system 500 is discussed in accordance with at least some embodiments of the present disclosure. The communication system 500 may be a distributed system and, in some embodiments, comprises a communication network 504 connecting one or more communication devices 508 to a work assignment mechanism 516, which may be owned and operated by an enterprise administering contact center 502 in which a plurality of resources 512 are distributed to handle incoming work items (in the form of contacts) from customer communication devices 508.

Contact center 502 is variously embodied to receive and/or send messages that are or are associated with work items and the processing and management (e.g., scheduling, assigning, routing, generating, accounting, receiving, monitoring, reviewing, etc.) of the work items by one or more resources 512. The work items are generally generated and/or received requests for a processing resource 512 embodied as, or a component of, an electronic and/or electromagnetically conveyed message. Contact center 502 may include more or fewer components than illustrated and/or provide more or fewer services than illustrated. The border indicating contact center 502 may be a physical boundary (e.g., a building, campus, etc.), legal boundary (e.g., company, enterprise, etc.), and/or logical boundary (e.g., resources 512 utilized to provide services to customers for a customer of contact center 502).

Furthermore, the border illustrating contact center 502 may be as-illustrated or, in other embodiments, include alterations and/or more and/or fewer components than illustrated. For example, in other embodiments, one or more of resources 512, customer database 518, and/or other component may connect to routing engine 532 via communication network 504, such as when such components connect via a public network (e.g., Internet). In another embodiment, communication network 504 may be a private utilization of, at least in part, a public network (e.g., VPN); a private network located, at least partially, within contact center 502; or a mixture of private and public networks that may be utilized to provide electronic communication of components described herein. Additionally, it should be appreciated that components illustrated as external, such as social media server 530 and/or other external data sources 534 may be within contact center 502 physically and/or logically, but still be considered external for other purposes. For example, contact center 502 may operate social media server 530 (e.g., a website operable to receive user messages from customers and/or resources 512) as one means to interact with customers via their customer communication device 508.

Customer communication devices 508 are embodied as external to contact center 502 as they are under the more direct control of their respective user or customer. However, embodiments may be provided whereby one or more customer communication devices 508 are physically and/or logically located within contact center 502, such as when a customer utilizes customer communication device 508 at a kiosk, attaches to a private network of contact center 502 (e.g., WiFi connection to a kiosk, etc.), within or controlled by contact center 502, and still be considered external to contact center 502.

It should be appreciated that the description of contact center 502 provides at least one embodiment whereby the following embodiments may be more readily understood without limiting such embodiments. Contact center 502 may be further altered, added to, and/or subtracted from without departing from the scope of any embodiment described herein and without limiting the scope of the embodiments or claims, except as expressly provided.

Additionally, contact center 502 may incorporate and/or utilize social media website 530 and/or other external data sources 534 may be utilized to provide one means for a resource 512 to receive and/or retrieve contacts and connect to a customer of a contact center 502. Other external data sources 534 may include data sources such as service bureaus, third-party data providers (e.g., credit agencies, public and/or private records), etc. Customers may utilize their respective customer communication device 508 to send/receive communications utilizing social media website 530.

In accordance with at least some embodiments of the present disclosure, the communication network 504 may comprise any type of known communication medium or collection of communication media and may use any type of protocols to transport electronic messages between endpoints. The communication network 504 may include wired and/or wireless communication technologies. The Internet is an example of the communication network 504 that constitutes an Internet Protocol (IP) network consisting of many computers, computing networks, and other communication devices located all over the world, which are connected through many telephone systems and other means. Other examples of the communication network 504 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 504 need not be limited to any one network type, and instead may be comprised of a number of different networks and/or network types. As one example, embodiments of the present disclosure may be utilized to increase the efficiency of a grid-based contact center 502. Examples of a grid-based contact center 502 are more fully described in U.S. Patent Publication No. 2010/0296417 to Steiner, the entire contents of which are hereby incorporated herein by reference. Moreover, the communication network 504 may comprise a number of different communication media, such as coaxial cable, copper cable/wire, fiber-optic cable, antennas for transmitting/receiving wireless messages, and combinations thereof.

The communication devices 508 may correspond to customer communication devices. In accordance with at least some embodiments of the present disclosure, a customer may utilize their communication device 508 to initiate a work item Illustrative work items include, but are not limited to, a contact directed toward and received at a contact center 502, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 504. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 516, but rather may be on some other server in the communication network 504 where it is harvested by the work assignment mechanism 516, which generates a work item for the harvested communication, such as social media server 530. An example of such a harvested communication includes a social media communication that is harvested by the work assignment mechanism 516 from a social media network or server 530. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively, each of which is hereby incorporated herein by reference in its entirety.

The format of the work item may depend upon the capabilities of the communication device 508 and the format of the communication. In particular, work items are logical representations within a contact center 502 of work to be performed in connection with servicing a communication received at contact center 502, and, more specifically, the work assignment mechanism 516. The communication may be received and maintained at the work assignment mechanism 516, a switch or server connected to the work assignment mechanism 516, or the like, until a resource 512 is assigned to the work item representing that communication at which point the work assignment mechanism 516 passes the work item to a routing engine 532 to connect the communication device 508, which initiated the communication, with the assigned resource 512.

Although the routing engine 532 is depicted as being separate from the work assignment mechanism 516, the routing engine 532 may be incorporated into the work assignment mechanism 516 or its functionality may be executed by the work assignment engine 520.

In accordance with at least some embodiments of the present disclosure, the communication devices 508 may comprise any type of known communication equipment or collection of communication equipment. Examples of a suitable communication device 508 include, but are not limited to, a personal computer, laptop, Personal Digital Assistant (PDA), cellular phone, smart phone, telephone, or combinations thereof. In general, each communication device 508 may be adapted to support video, audio, text, and/or data communications with other communication devices 508 as well as the processing resources 512. The type of medium used by the communication device 508 to communicate with other communication devices 508 or processing resources 512 may depend upon the communication applications available on the communication device 508.

In accordance with at least some embodiments of the present disclosure, the work item is sent toward a collection of processing resources 512 via the combined efforts of the work assignment mechanism 516 and routing engine 532. The resources 512 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact center 502.

As discussed above, the work assignment mechanism 516 and resources 512 may be owned and operated by a common entity in a contact center 502 format. In some embodiments, the work assignment mechanism 516 may be administered by multiple enterprises, each of which has its own dedicated resources 512 connected to the work assignment mechanism 516.

In some embodiments, the work assignment mechanism 516 comprises a work assignment engine 520, which enables the work assignment mechanism 516 to make intelligent routing decisions for work items. In some embodiments, the work assignment engine 520 is configured to administer and make work assignment decisions in a queueless contact center 502, as is described in U.S. patent application Ser. No. 12/882,950, the entire contents of which is hereby incorporated herein by reference. In other embodiments, the work assignment engine 520 may be configured to execute work assignment decisions in a traditional queue-based (or skill-based) contact center 502.

The work assignment engine 520 and its various components may reside in the work assignment mechanism 516 or in a number of different servers or processing devices. In some embodiments, cloud-based computing architectures can be employed whereby one or more components of the work assignment mechanism 516 are made available in a cloud or network such that they can be shared resources among a plurality of different users. Work assignment mechanism 516 may access customer database 518, such as to retrieve records, profiles, purchase history, previous work items, and/or other aspects of a customer known to contact center 502. Customer database 518 may be updated in response to a work item and/or input from resource 512 processing the work item.

In one embodiment, a message is generated by customer communication device 508 and received, via communication network 504, at work assignment mechanism 516. The message received by a contact center 502, such as at the work assignment mechanism 516, is generally, and herein, referred to as a “contact.” Routing engine 532 routes the contact to at least one of resources 512 for processing.

In one embodiment, a conference is provided between one or more resources 512 and customer utilizing customer device 508. For example, a customer may be interacting with an automated resource 512 whereby server 106 provides validation of the spoken content provided by the customer for use by the customer and/or use by an automated resource 512 or for the later review by human resource 512. Additionally, a communication session between resource 512 and a customer using customer communication device 508 may be validated by server 106.

Server 106 is variously embodied and may comprise, be co-processed with, or be comprised by one or more of work assignment engine 520, work assignment mechanism 516, and routing engine 532. In another embodiment, server 106 may be distinct from work assignment engine 520, work assignment mechanism 516, and routing engine 532 or co-processed with, comprised by, or comprise other components.

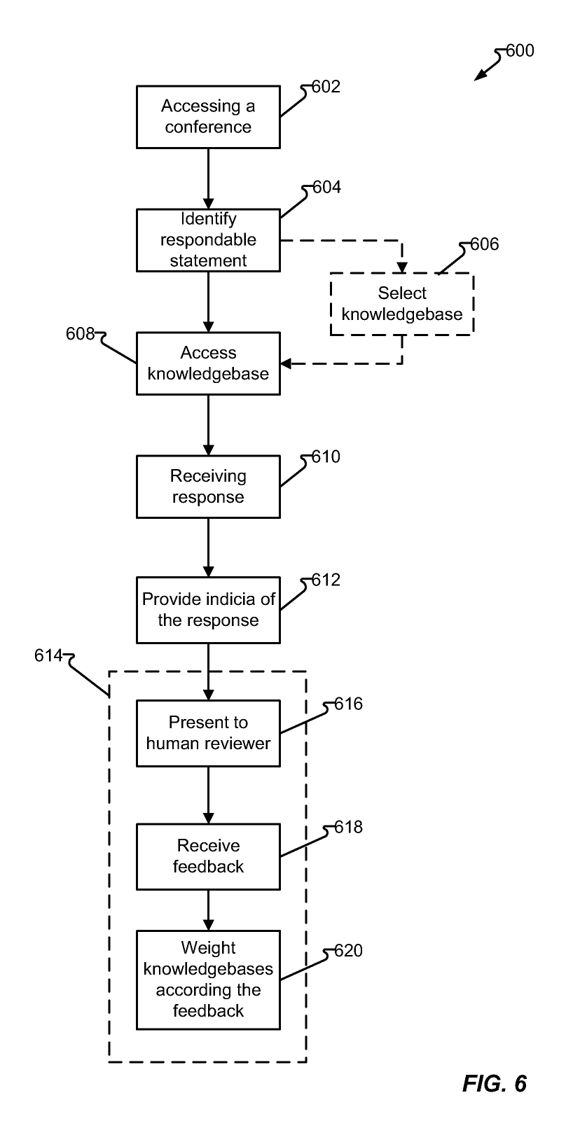

FIG. 6 depicts process 600 in accordance with embodiments of the present disclosure. In one embodiment, process 600 begins at step 602 accessing a conference. The conference accessed in step 602 may be a single-party dictation or a multi-party conference in real-time or as a playback from a recorded dictation or conference. Next, step 604 identifies a respondable statement. A respondable statement may be an explicit question or other query or statement of fact that may be verified. For example, server 106 monitoring a conference between speakers 102 may determine an explicit question has been asked, the question asked has not been answered, a statement of fact made, and/or a reference made which may be verified or additional information identified, such as for later access.

Step 608 accesses one or more knowledgebases in order to provide search results associated with the respondable statement. Optionally, step 606 may be provided under to select a specific knowledgebase 108,110 from a plurality of knowledgebases 108,110. Step 604 may identify a respondable statement associated with a particular topic or persons. Accordingly, step 606 may perform access step 608 upon a particular knowledgebase 108,110 associated with the topic or persons. For example, step 604 may identify a respondable statement regarding a meeting with a particular department of an organization. Accordingly, step 606 performs access step 608 on scheduling data associated with the department or personnel within the department. In another example, step 604 identifies a more generic datum (e.g., weather, traffic, history, etc.) accessible via an external source, such as a search engine accessible via the Internet. Accordingly, step 606 then performs access step 608 upon the identified search engine. As a further option, step 606 may be seeded with prior results associated with feedback to weight, include, or exclude based upon prior successes associated with prior results (see FIG. 3).

Step 610 then receives the response from the one or more knowledgebases 108,110 accessed in step 608. Step 610 may perform additional processing, such as cross-referencing, validation, scoring, waiting, etc. upon the results received from one or more knowledgebases 108,110. Step 612 provides indicia of the response presentable to a human user and/or automated system. Step 612 may present the results received in step 610 in textual, audible, graphical, tactile, and/or other format to identify the presence of the response and/or at least a portion of the response received in step 610. Step 612 may be provided as an annotation to a transcript (See FIG. 4) or application displayed on a display device (See FIG. 3). Step 612 may be scored, weighted, or otherwise evaluated for presentation without human input. Additionally, step 612 may provide identification of a source of the information received during step 610. As a further embodiment, step 612 may limit the information provided in response to a security setting associated with the content, source, search result, etc. and a viewer of the information.

In one embodiment, process 600 may end following step 612, with respect to a particular dictation or conference or component thereof. As such, an embodiment, the output from step 612, may be hidden by a user, such as to avoid distraction during a conference. Optionally, process 612 may include step 614, comprising steps 616, 618, and 620. Step 616 provides a presentation to a human reviewer. The human reviewer may be a conference participant, a person performing a dictation, or a party reviewing a recorded conference or dictation. Next, step 618 receives feedback, which may be further embodied in the selection of a response from a number of responses provided to the human reviewer in step 616. For example, one particular knowledgebase may be deemed to be more beneficial to a user and therefore feedback received in step 618 may then indicate the greater popularity and/or usefulness of that particular knowledgebase. Accordingly, step 620 may then provide a weighting whereby a particular knowledgebase is utilized more frequently, less frequently, excluded, or included with respect to all conferences and dictations and/or conferences and dictations identified as having a particular subject matter and/or involving particular individuals.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a network connection configured to access a conference stream comprising conference content provided by a number of conference participants;
a processor configured to analyze the conference stream to identify a respondable statement provided by at least one of the number of conference participants;
the processor being further configured to, upon identifying the respondable statement, access a knowledgebase and obtain a response to the respondable statement from the knowledgebase; and
the processor being further configured to provide indicia of the response.

2. The system of claim 1, wherein the respondable statement comprises a question.

3. The system of claim 1, wherein the conference stream comprises a real-time conference feed.

4. The system of claim 1, further comprising a speech-to-text conversion module and wherein the speech-to-text conversion module converts a spoken portion of the conference stream to a text counterpart of the conference stream and wherein the processor is further configured to analyze the text portion of the conference stream.

5. The system of claim 1, wherein the processor is further configured to determine a topic of the respondable statement, develop an inferred question associated with the respondable statement, obtain a response to the inferred questions from the knowledgebase, and provide indicia of the response to the inferred question.

6. The server of claim 1, wherein the response from the knowledgebase comprises a plurality of responses and wherein the processor is further configured to present indicia of the plurality of responses.

7. The server of claim 6, wherein the processor is further configured to analyze the plurality of responses to determine a ranking of the plurality of responses and present the indicia as ranked indicia of the plurality of responses.

8. The server of claim 1, wherein:
the processor is further configured to receive a user input in reply to a request for the user to verify the validity of the response and utilize the user input to select the knowledgebase from a plurality of knowledgebases for a future respondable statement determined to be at least substantially similar to the respondable statement.

9. The server of claim 1, wherein the indicia further comprises identification of the source of the response within the knowledgebase.

10. The server of claim 1, wherein the processor is further configured to determine a topic of the respondable statement and perform the accessing of the knowledgebase upon determining the topic is associated with a respondable topic and not performing the response upon determining the topic is not associated with the respondable topics.

11. The server of claim 1, wherein the processor is further configured to produce a transcript of the conference comprising the indicia.

12. A method, comprising:
accessing a conference stream comprising conference content provided by a number of conference participants;
analyzing the conference stream to identify a respondable statement provided by at least one of the number of conference participants;
upon identifying the respondable statement, accessing a knowledgebase and receiving a response to the respondable statement from the knowledgebase; and
providing indicia of the response.

13. The method of claim 12, further comprising:
performing a speech-to-text conversion module and wherein the speech-to-text conversion module converts a spoken portion of the conference stream to a text counterpart of the conference stream and wherein the processor is further configured to analyze the text portion of the conference stream.

14. The method of claim 12, further comprising:
determining a topic of the respondable statement;
developing an inferred question associated with the respondable statement;
obtaining a response to the inferred questions from the knowledgebase; and
providing indicia of the response to the inferred question.

15. The method of claim 12, wherein:
the response from the knowledgebase comprises a plurality of responses and wherein the processor is further configured to present indicia of the plurality of responses;
the step of analyzing further comprises analyzing the plurality of responses to determine a ranking of the plurality of responses; and
the step of presenting the indicia further comprises presenting the indicia as ranked indicia of the plurality of responses.

16. The method of claim 12, further comprising:
receiving a user input in reply to a request for the user to verify the validity of the response; and
utilizing the user input as a selection criterion of the knowledgebase from a plurality of knowledgebases for a future respondable statement determined to be at least substantially similar to the respondable statement.

17. The method of claim 12, wherein the indicia further comprises identification of the source of the response within the knowledgebase.

18. A non-transitory computer-readable medium with instructions thereon that when read by the computer cause the computer to perform:
accessing a conference stream comprising conference content provided by a number of conference participants;
analyzing the conference stream to identify a respondable statement provided by at least one of the number of conference participants;
upon identifying the respondable statement, accessing a knowledgebase and responding to the respondable statement with the knowledgebase; and
providing indicia of the response.

19. The non-transitory medium of claim 18, further comprising instructions to cause the computer to perform:
determining a topic of the respondable statement;
developing an inferred question associated with the respondable statement;
obtaining a response to the inferred questions from the knowledgebase; and
providing indicia of the response to the inferred question.

20. The non-transitory medium of claim 18, wherein the indicia further comprises identification of the source of the response within the knowledgebase.
